(19) United States
(12) Patent Application Publication
(10) Pub. No.: US 2024/0135236 A1
(43) Pub. Date: Apr. 25, 2024

(54) TRANSACTION CLASSIFYING

(71) Applicant: Bank of America Corporation, Charlotte, NC (US)

(72) Inventors: Krishna Reddy Mandala, Hyderabad Telangana (IN); Ananya Bhattacharyya, Gurugram Haryana (IN); Ashutosh Misra, Gurugram Haryana (IN); Marc Halsted, Charlotte, NC (US); David Joa, San Francisco, CA (US)

(21) Appl. No.: 17/972,637

(22) Filed: Oct. 24, 2022

(51) Int. Cl. G06N 20/00; G06Q 20/38

(52) U.S. Cl. CPC G06N 20/00; G06Q 20/389

(57) ABSTRACT

Apparatus and methods for intelligently classifying unclassified transactions are provided. A program may receive a set of transaction data. The program may divide the set into a training set of classified transactions and a test set of unclassified transactions. The program may analyze the training set to generate a document term matrix. The program may analyze the test set and compare the analyzed terms to the document term matrix to predict a classification. The program may iterate to a pre-determined level of confidence in the prediction and assign a classification to a particular transaction.

### FIELD OF TECHNOLOGY

Aspects of the disclosure relate to providing apparatus and methods to intelligently classify unclassified transactions.

### BACKGROUND OF THE DISCLOSURE

Financial institutions and other entities may log millions of transactions across their networks every day. Information included within the logs may be used for various purposes. The information may be mined for revenue enhancement opportunities. The information may be analyzed to mitigate risk to the financial institution or its customers.

The information within the log may include a nature of each transaction, such as what type of business the entity conducts. For example, sending money to a homeowner's association may be classified as an “HOA” code. Or a transaction showing a gas station receiving money at a gas pump may be classified as “GAS”, while a transaction as the same gas station showing the station receiving money in a connected car wash should be classified as “CAR WASH”. These descriptions may be referred to as a “transaction category code.” The more granular the transaction category code, the more useful the information may be to the financial institution. The number and description of each transaction category code may be determined by the entity, for the entity's purposes.

Currently, transaction category codes may be assigned using a simple set of rules in a ‘waterfall’ approach. However, this may leave a large number (and sometimes a majority) of transactions classified as “OTHER”. An “OTHER” transaction code does not convey enough information for analysis, and entities may have to manually review each “OTHER” entry to determine an appropriate code. This may be time-consuming and expensive.

Currently, there is no apparatus or method available to intelligently classify transactions within a transaction log to significantly reduce or eliminate the appearance of “OTHER” transaction codes without manual input.

Therefore, it would be desirable for apparatus and methods to intelligently classify previously unclassified or unknown transactions without manual input.

### SUMMARY OF THE DISCLOSURE

It is an object of this disclosure to provide apparatus and methods for intelligently classifying unclassified or unknown transaction data.

An intelligent transaction classifying computer program product is provided. The computer program product may include executable instructions. The executable instructions may be executed by a processor on a computer system.

The executable instructions may be configured to receive a training set of transaction data. The training set of transaction data may include two or more training transactions. Each training transaction comprising may include: a business name, a short description, and a transaction category code. The training transactions may include other information as well.

The instructions may store the training set in a non-transitory memory. The instructions may pre-process the training set.

The instructions may analyze, through one or more artificial intelligence/machine learning (“AI/ML”) algorithms, the training set. The analysis may be configured to determine one or more unique characteristics of each training transaction correlating to the transaction category code, such as the name, description, and other characteristics. Each of the one or more unique characteristics may include a training unigram.

The instructions may generate a document term matrix, which may include rows and columns. Each row of the document term matrix may include one of the training unigrams. One column may include a frequency of each unigram within the training set (e.g., if the unigram appears within 10% of the training transactions, its frequency will be 10%; alternatively, if a training unigram always appears with the same transaction category code, its frequency for that code will be 100%). One column may include a transaction category code that is associated with that particular training unigram.

The instructions may be configured to receive a test set of transaction data. The test set may include two or more test transactions. Each test transaction may include: a business name, a short description, an “OTHER” transaction category code, as well as other data.

The instructions may store the test set in the non-transitory memory. The instructions may pre-process the test set.

The instructions may analyze, through one or more artificial intelligence/machine learning (“AI/ML”) algorithms, the test set to determine one or more unique characteristics of each test transaction. Each of the one or more unique characteristics may include a test unigram.

The instructions may compare, through one or more comparison artificial intelligence/machine learning (“cAI/ML”) algorithms, each test unigram to the document term matrix to determine a predicted transaction category code for each test transaction. The instructions may iterate the comparison and determination to a pre-determined threshold level of confidence in the predicted transaction category code.

The instructions may assign the predicted transaction category code to a corresponding test transaction, thereby creating a classified test set of transaction data.

In an embodiment, the intelligent transaction classifying computer program product may add the classified test set of transaction data to the training set, creating a new and larger training set.

In an embodiment, the pre-processing may include removing whitespace.

In an embodiment, the pre-processing may include removing punctuation marks.

In an embodiment, one of the one or more cAI/ML algorithms may be or include a recurrent neural network model.

In an embodiment, the recurrent neural network model may be or include a long-short term memory model (“LSTM”).

In an embodiment, the LSTM may be bidirectional. For example, the LSTM may analyze both the preceding unigram and subsequent unigram (if any) along with a particular unigram in a particular test or training transaction.

In an embodiment, each training transaction further may include a business name aggregate.

In an embodiment, each test transaction further may include a business name aggregate.

In an embodiment, the training set may include more than seven hundred unique transaction category codes.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative apparatus in accordance with principles of the disclosure.

FIG. 2 shows an illustrative apparatus in accordance with principles of the disclosure.

FIG. 3 shows an illustrative schematic in accordance with principles of the disclosure.

FIG. 4 shows an illustrative schematic in accordance with principles of the disclosure.

FIG. 5 shows an illustrative flowchart in accordance with principles of the disclosure.

FIG. 6 shows an illustrative data set in accordance with principles of the disclosure.

### DETAILED DESCRIPTION OF THE DISCLOSURE

It is an object of this disclosure to provide apparatus and methods for intelligently classifying unclassified or unknown transaction data.

An intelligent transaction classifying computer program product is provided. The computer program product may include executable instructions. The executable instructions may be executed by a processor on a computer system to perform various functions.

Multiple processors may increase the speed and capability of the program. The executable instructions may be stored in non-transitory memory on the computer system or a remote computer system, such as a server.

Other standard components of a computer system may be present. The computer system may be a server, mobile device, or other type of computer system. A server or more powerful computer may increase the speed at which the computer program may run. Portable computing devices, such as a smartphone, may increase the portability and usability of the computer program, but may not be as secure or as powerful as a server or desktop computer.

The term “non-transitory memory,” as used in this disclosure, is a limitation of the medium itself, i.e., it is a tangible medium and not a signal, as opposed to a limitation on data storage types (e.g., RAM vs. ROM). “Non-transitory memory” may include both RAM and ROM, as well as other types of memory.

In an embodiment, the intelligent transaction classifying computer program may be executed on an apparatus. The apparatus may include a computer. The computer may be a server, desktop computer, mobile computer, tablet, or other type of computer.

The computer may include a communication link, a processor or processors, and a non-transitory memory configured to store executable data configured to run on the processor, among other components. The executable data may include an operating system and the transaction classifying computer program.

A processor(s) may control the operation of the apparatus and its components, which may include RAM, ROM, an input/output module, and other memory. The microprocessor may also execute all software running on the apparatus. Other components commonly used for computers, such as EEPROM or Flash memory or any other suitable components, may also be part of the apparatus.

A communication link may enable communication with other computers as well as any server or servers. The communication link may include any necessary hardware (e.g., antennae) and software to control the link. Any appropriate communication link may be used. In an embodiment, the network used may be the Internet. In another embodiment, the network may be an internal intranet.

The computer system may be a server. The computer program may be run on a smart mobile device. The computer program, or portions of the computer program may be linked to other computers or servers running the computer program. The server or servers may be centralized or distributed. Centralized servers may be more powerful and secure than distributed servers but may also be more expensive.

The executable instructions may be configured to receive a training set of transaction data. The training set may be transmitted directly to the program, or the program may retrieve the data from a repository. The repository may be the Internet. The data may be transmitted over the Internet or other network. The data may be received through a physical medium, such as a USB thumb drive, recordable media, or other transportable digital media device.

The transaction data may be actual data or exemplary data. The transaction data may be in the form of a spreadsheet, database data, or other suitable format. The training set of transaction data may include two or more training transactions. Typical transaction data sets may include thousands or millions of transactions. Each part of the transaction may be in a separate data cell. The more transactions, the more accurate the program may be in classifying unknown transactions. Transactions may be duplicated. Transactions may be unique. Each training transaction may include: a business name, a short description, and a transaction category code. The training transactions may include other information as well.

Typical transaction data may describe a payment from customer A in amount N to entity Z. Other information may be included in a transaction.

The business name, short description, and other information may be provided by a business when setting up a transaction account. For example, if a business wants to start accepting certain types of credit cards or wants to honor checks or debit cards from a particular financial institution, the business may have to register an account. When registering the account, the business may provide a business name and a short description.

The business name may be the legal name for the entity involved in the transaction. A business name aggregate may be a shortened or aggregated name that may be utilized to help classify transactions or for other uses. A short description may be a short description of the type of business, or a short description of goods or services purchased. A product consumer business code may classify each transaction as a consumer transaction, a business transaction (entity to entity), or other possibilities.

A transaction category code may describe a category to which a particular transaction belongs. Each financial institution or entity may have their own unique set of transaction category codes. Some entities may have hundreds or thousands of transaction category codes. Transaction category codes may be analyzed by a financial institution or other entity for risk purposes, compliance, market research, business opportunities, or other purposes.

An exemplary transaction category code may be “GOV” for a transaction with a government entity, such as a tax payment. Another exemplary code may be “GAS” for a purchase of gasoline. Another exemplary code may be “CPA” or “PRO” (short for ‘professional’) for a payment with an accounting firm.

The instructions may store the training set in a non-transitory memory. This may be the same or different non-transitory memory that stores the computer program or other data.

The instructions may pre-process the training set. Pre-processing may include actions such as removing whitespaces, trailing blanks, punctuation marks, digits, and other extraneous data. This extraneous data may be removed from any data cell, but may be important to remove from business name, business name aggregate, and short description data cells. Pre-processing the data may help improve the program's accuracy and speed. The pre-processing may be done automatically. The pre-processing may be initiated by a system administrator.

In an embodiment, an artificial intelligence/machine learning algorithm or algorithms may perform the pre-processing of the data. An AI/ML algorithm performing the pre-processing may be able to learn and improve, as well as adapt to future contingencies faster than a set list of pre-processing rules.

The instructions may analyze, through one or more artificial intelligence/machine learning (“AI/ML”) algorithms, the training set. The analysis may be configured to determine one or more unique characteristics of each training transaction correlating to the transaction category code, such as the name, description, and other characteristics. Each of the one or more unique characteristics may include a training unigram. For example, a business name may be “ACCOUNTING FIRM ABC”, the short description may state “accounting services,” and the transaction category code may be “CPA”. Each of the following terms may be a training unigram, and each may be associated with the CPA transaction category code: “ACCOUNTING”, “FIRM”, “ABC”, and “services”. The program may also determine the frequency at which each of these words appears in the training set, and the frequency at which each word appears with the “CPA” transaction code. For example, if “ACCOUNTING” always appears with the CPA code, the frequency will be 100%, while if “services” appears 1/10 times with “CPA” and 9/10 times with other codes, the frequency will be 10%. These characteristics and analysis may be incorporated into a document term matrix.

The instructions may generate a document term matrix, which may include rows and columns. The document term matrix may be a spreadsheet, database, or in any other suitable format.

Each row of the document term matrix may include one of the training unigrams. The larger the training transaction data set, the larger the document term matrix may be. One column may include a frequency of each unigram within the training set (e.g., if the unigram appears within 10% of the training transactions, its frequency will be 10%; alternatively, or in addition, if a training unigram always appears with the same transaction category code, its frequency for that code will be 100%). One column may include a transaction category code that is associated with that particular training unigram. Additional columns, with additional data, may be added as needed or desired.

The program's instructions may be configured to receive a test set of transaction data. The program may receive the test set through the same method as the training data. The program may receive the test set through a different method than the training data.

In an embodiment, the program may be configured to divide a larger set of transaction data into a training set and a test set.

The test set may include two or more test transactions. Each test transaction may include: a business name, a short description, an “OTHER” or blank transaction category code, as well as other data. A transaction may be determined to belong to the test set based solely on the “OTHER” or blank transaction category code. If a transaction has a defined transaction category code, it should be placed in the training set.

The instructions may store the test set in the non-transitory memory. The instructions may pre-process the test set. Pre-processing the test set may be similar to the pre-processing of the training set.

The instructions may analyze, through one or more artificial intelligence/machine learning (“AI/ML”) algorithms, the test set to determine one or more unique characteristics of each test transaction. Each of the one or more unique characteristics may include a test unigram. For example, the analysis may determine unique unigrams for each transaction. The more unique unigrams, the more points of comparison that may be available to compare with the document term matrix. Any suitable AI/ML algorithm or combination of algorithms may be used.

The instructions may compare, through one or more comparison artificial intelligence/machine learning (“cAI/ML”) algorithms, each test unigram to the document term matrix to determine a predicted transaction category code for each test transaction. For example, an “ACCOUNTING” unigram in the test set may be compared to “ACCOUNTING” unigrams in the document term matrix. If, by example only, “ACCOUNTING” appears 100 times in the document term matrix, 35 times with category code CPA, 35 times with category code PROF(essional), and 30 times with category code TAX, the cAI/ML algorithm or algorithms may determine that there is a different probability for each of these three categories.

The instructions may iterate the comparison and determination to a pre-determined threshold level of confidence in the predicted transaction category code. The comparison may be to a pre-determined threshold of accuracy, such as 75% or 90%.

As in the example above, the cAI/ML algorithms may be iterated to determine the most probable category code. In this example, the cAI/ML algorithms may analyze the unigram before and/or after other unigrams in that particular transaction and compare it to the document term matrix in the next iteration. This comparison may be combined with the previous comparison to strengthen the predicted transaction category code. For example, (using the same numbers as above), if the subsequent unigram is “TAX”, which appears in the document term matrix with a 100% frequency for category code TAX, the cAI/ML may predict that the category code should be TAX, instead of CPA or PROF.

The instructions may then assign the predicted transaction category code to a corresponding test transaction, thereby creating a classified set of transaction data. For example, the test transaction with “ACCOUNTING” and “TAX” unigrams may be assigned a category code of “TAX” and become a classified transaction instead of an unclassified transaction.

In an embodiment, the intelligent transaction classifying computer program product may add the classified test set of transaction data to the training set, creating a new and larger training set. The more data points within the training set, the more accurate the program may be in classifying “OTHER” transactions.

In an embodiment, the pre-processing may include removing whitespace, punctuation marks, digits, and other artifacts.

In an embodiment, one of the one or more cAI/ML algorithms may be or include a recurrent neural network model. A recurrent neural network may allow an output result from one node in the model to affect an input to the same node, creating a cycle. In other words, recurrent neural networks may incorporate memories of past calculations or inputs to determine new inputs. There may be multiple different recurrent neural networks, each with their own advantages and disadvantages.

Recurrent neural networks may be analogized to the way a human brain functions, and can be used to model complex, non-linear patterns and relationships dynamically.

In an embodiment, the recurrent neural network model may be or include a long-short term memory model (“LSTM”). LSTMs are one type of recurrent neural networks. LSTMs may have an input layer, a hidden layer, and an output layer. The hidden layer may be dynamic and may feedback to the input layer dynamically, creating a cycle. LSTMs may have both long term and short-term memory, i.e., an LSTM may be able to analyze relationships between distant and near data-points. LSTMs may be able to incorporate data over thousands of iterations (or time-steps).

In an embodiment, the LSTM may be bidirectional. For example, the LSTM may analyze both the preceding unigram and subsequent unigram (if any) along with a particular unigram in a particular test or training transaction. For example, if a business name includes 5 unigrams, the LSTM can analyze each unigram on its own, with a subsequent unigram, with a preceding unigram, with all four other unigrams, with three other unigrams, or in any other possible combination of the five unigrams. The LSTM may also take into account the position of a particular unigram within the set of unigrams for a particular transaction. The more data points analyzed, the more accurate the predicted transaction category code may be.

In an embodiment, each training transaction and/or test transaction may also include a business name aggregate. Including a business name aggregate may increase the data points available for analysis, increasing the accuracy of the program.

The training set may include more than seven hundred unique transaction category codes. The number of unique transaction category codes provided may be dependent on the amount of training data, as well as a particular entity utilizing the program.

An intelligent transaction classifying computer program product is provided. The computer program product may include executable instructions. The executable instructions may be executed by a processor on a computer system.

The instructions may be configured to receive a set of transaction data. The set of transaction data may include two or more transactions. Each transaction may include: a business name, a short description, a business name aggregate, and a transaction category code.

The instructions may be configured to store the set in a non-transitory memory. The instructions may pre-process the set. The instructions may automatically divide the set into one or more training transactions and one or more test transactions. Each of the one or more test transactions may include have a transaction category code labeled as OTHER or variations of OTHER (e.g., OTH or OTR). Any transaction with a defined transaction category code may be included in the training transaction set.

The instructions may generate a training document term matrix from the one or more training transactions. The training document term matrix may include multiple rows and columns. Each row may include a training unigram, one column may include a frequency of each training unigram within the set (correlated to the entire set or correlated to transaction category code), and one column may include an associated transaction category code. The training unigram may be taken or derived from the business name, the short description, or the business name aggregate.

The instructions may generate a test document term matrix from the one or more test transactions. The test document term matrix may include multiple rows and columns. Each row may include a test unigram, one column may include a frequency of each test unigram within the set (correlated to the set), and one column may be empty. Each test unigram may be taken from the business name, the short description, or the business name aggregate of a particular test transaction.

The instructions may complete the test document term matrix by comparing, through one or more comparison artificial intelligence/machine learning (“cAI/ML”) algorithms, each test unigram to the training document term matrix to determine a predicted transaction category code for each of the one or more test transactions.

The instructions may iterate the completion and determination actions to a pre-determined threshold level of confidence in the predicted transaction category code.

The instructions may assign the predicted transaction category code to a corresponding test transaction of the one or more test transactions, thereby creating a classified set of transaction data.

In an embodiment, the predicted transaction category code may also be OTHER, or a derivative of OTHER. In this embodiment, the cAI/ML may have been unable to accurately determine a predicted transaction category code. Instead of guess below pre-determined threshold of accuracy, the program may maintain the transaction category code as “OTHER”.

In an embodiment, the pre-determined threshold level of confidence may be modifiable by an administrator or the program.

In an embodiment, an artificial intelligence/machine learning (“AI/ML”) algorithm within the program may modify the pre-determined threshold level. For example, if a significant number of transactions are returning still classified as “OTHER”, the AI/ML algorithm may determine that the threshold level of accuracy is too high and lower the threshold level. For example, if 50% of transactions are classified as “OTHER” at a 90% threshold level, the AI/ML (or an administrator) may lower the threshold level in 5% increments, until only 10% of transactions are classified as “OTHER”.

In an embodiment, a system administrator may adjust or modify the pre-determined threshold level of confidence.

In an embodiment, the classified set of transaction data may be data-mined. Data mining the classified set may include applying various algorithms to the data to determine data trends or other information about the entire set. Individual transactions may be data-mined as well. Any entity or individual running the program may determine which data to mine and how to mine the data according to its own needs.

In an embodiment, an artificial intelligence/machine learning (“AI/ML”) algorithm may data-mine the classified set of transaction data.

A method for intelligently classifying transactions is provided. The method may include the step of receiving, by an intelligent transaction classifying computer program on a centralized server, a training set of transaction data. The training set may include two or more training transactions. Each training transaction may include: a business name, a short description, and a transaction category code.

The method may include the step of storing the training set in a non-transitory memory on the centralized server or elsewhere.

The method may include the step of pre-processing, by the computer program, the training set.

The method may include the step of analyzing, by the computer program and through one or more artificial intelligence/machine learning (“AI/ML”) algorithms, the training set to determine one or more unique characteristics of each training transaction correlating to the transaction category code. Each of the one or more unique characteristics may include a training unigram.

The method may include the step of generating, by the computer program, a document term matrix. The document term matrix may include one or more rows and two or more columns. Each row may include one of the training unigrams, one column may include a frequency of each unigram within the training set (either correlated to the times the unigram appears in the set or the times the unigram appears with respect to a particular transaction category code). One column may include a transaction category code associated with that particular unigram.

The method may include the step of receiving, by the computer program, a test set of transaction data. The test set may include two or more test transactions. Each test transaction may include: a business name, a short description, and an “OTHER” transaction category code.

The method may include the step of storing the test set in the non-transitory memory.

The method may include the step of pre-processing, by the computer program, the test set.

The method may include the step of analyzing, by the computer program and through one or more artificial intelligence/machine learning (“AI/ML”) algorithms, the test set to determine one or more unique characteristics of each test transaction. Each of the one or more unique characteristics may include a test unigram.

The method may include the step of comparing, by the computer program and through one or more comparison artificial intelligence/machine learning (“cAI/ML”) algorithms, each test unigram to the document term matrix to determine a predicted transaction category code for each test transaction.

The method may include the step of iterating, by the computer program, the comparison and determination to a pre-determined threshold level of confidence in the predicted transaction category code.

The method may include the step of assigning, by the computer program, the predicted transaction category code to a corresponding test transaction, thereby creating a classified test set of transaction data.

In an embodiment, one of the one or more cAI/ML algorithms may be a recurrent neural network model.

In an embodiment, the recurrent neural network model may include a long-short term memory model (“LSTM”).

One of ordinary skill in the art will appreciate that the steps shown and described herein may be performed in other than the recited order and that one or more steps illustrated may be optional. Apparatus and methods may involve the use of any suitable combination of elements, components, method steps, computer-executable instructions, or computer-readable data structures disclosed herein.

Illustrative embodiments of apparatus and methods in accordance with the principles of the invention will now be described with reference to the accompanying drawings, which form a part hereof. It is to be understood that other embodiments may be utilized, and that structural, functional, and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

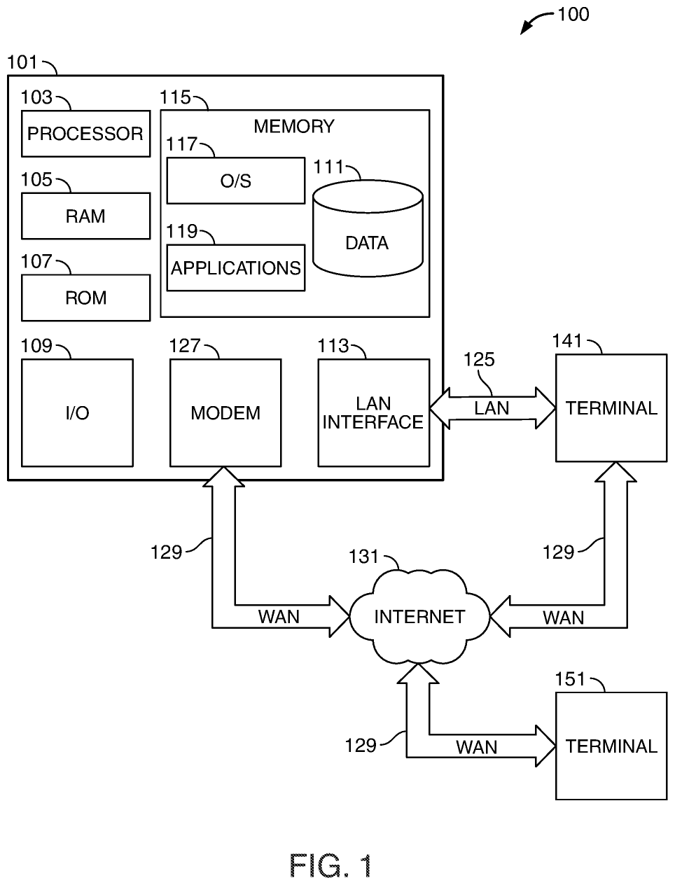

In accordance with principles of the disclosure, FIG. 1 shows an illustrative block diagram of apparatus 100 that includes a computer 101. Computer 101 may alternatively be referred to herein as a “computing device.” Elements of apparatus 100, including computer 101, may be used to implement various aspects of the apparatus and methods disclosed herein. A “user” of apparatus 100 or computer101 may include other computer systems or servers or a human, such as the program described herein.

Computer 101 may have one or more processors/microprocessors 103 for controlling the operation of the device and its associated components, and may include RAM 105, ROM 107, input/output module 109, and a memory 115. The microprocessors 103 may also execute all software running on the computer 101—e.g., the operating system 117 and applications 119 such as an intelligent transaction classifying program and security protocols. Other components commonly used for computers, such as EEPROM or Flash memory or any other suitable components, may also be part of the computer 101.

The memory 115 may be comprised of any suitable permanent storage technology—e.g., a hard drive or other non-transitory memory. The ROM 107 and RAM 105 may be included as all or part of memory 115. The memory 115 may store software including the operating system 117 and application(s) 119 (such as an intelligent transaction classifying program and security protocols) along with any other data 111 (test and training transaction sets) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, wi-fi, cellular networks, or other suitable frequencies.

Any memory may be comprised of any suitable permanent storage technology—e.g., a hard drive or other non-transitory memory. The memory may store software including an operating system and any application(s) (such as an intelligent transaction classifying program and security protocols) along with any data needed for the operation of the apparatus and to allow authentication of a user. The data may also be stored in cache memory, or any other suitable memory.

An input/output (“I/O”) module 109 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 101, the microprocessor 103 may execute the instructions in all or some of the operating system 117, any applications 119 in the memory 115, any other code necessary to perform the functions in this disclosure, and any other code embodied in hardware or firmware (not shown).

In an embodiment, apparatus 100 may consist of multiple computers 101, along with other devices. A computer 101 may be a mobile computing device such as a smartphone or tablet.

Apparatus 100 may be connected to other systems, computers, servers, devices, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refer to applications located on a server remote from a user, wherein some or all of the application data, logic, and instructions are located on the internet and are not located on a user's local device. Cloud-based applications may be accessed via any type of internet connection (e.g., cellular or wi-fi).

Terminals 141 and 151 may be personal computers, smart mobile devices, smartphones, or servers that include many or all of the elements described above relative to apparatus 100. The network connections depicted in FIG. 1 include a local area network (LAN) 125 and a wide area network (WAN) 129 but may also include other networks. Computer 101 may include a network interface controller (not shown), which may include a modem 127 and LAN interface or adapter 113, as well as other components and adapters (not shown). When used in a LAN networking environment, computer 101 is connected to LAN 125 through a LAN interface or adapter 113. When used in a WAN networking environment, computer 101 may include a modem 127 or other means for establishing communications over WAN 129, such as Internet 131. The modem 127 and/or LAN interface 113 may connect to a network via an antenna (not shown). The antenna may be configured to operate over Bluetooth, wi-fi, cellular networks, or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for an intelligent transaction classifying program and security protocols, as well as other programs. In an embodiment, one or more programs, or aspects of a program, may use one or more AI/ML algorithm(s). The various tasks may be related to classifying unclassified transactions for various purposes.

Computer 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, server, or any other suitable device for receiving, storing, transmitting and/or displaying relevant information. Terminal 151 and/or terminal 141 may be other devices such as remote computers or servers. The terminals 151 and/or 141 may be computers where a user is interacting with an application.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, hand-held or laptop devices, tablets, mobile phones, smart phones, other Computers, and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media including memory storage devices.

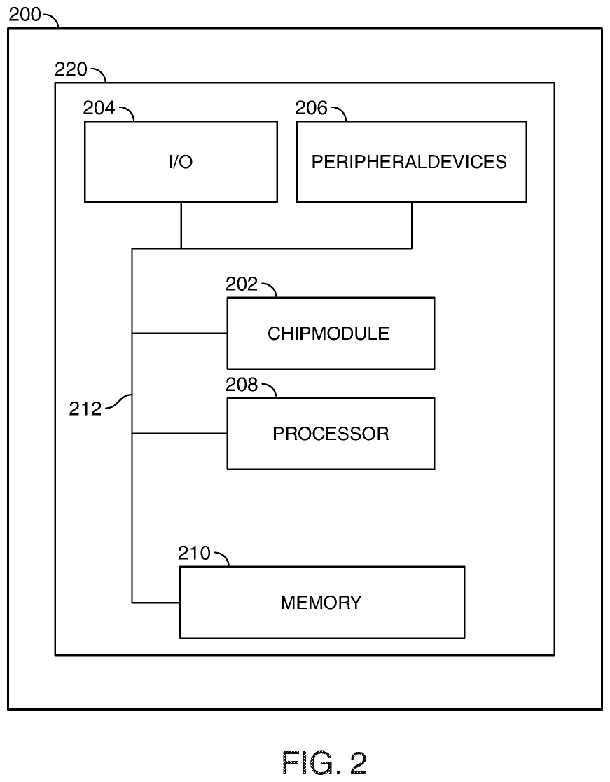

FIG. 2 shows illustrative apparatus 200 that may be configured in accordance with the principles of the disclosure. Apparatus 200 may be a server or computer with various peripheral devices 206. Apparatus 200 may include one or more features of the apparatus shown in FIGS. 1, 3, and 6. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, an display (LCD, LED, OLED, etc.), a touchscreen or any other suitable media or devices; peripheral devices 206, which may include other computers; logical processing device 208, which may compute data information and structural parameters of various applications; and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

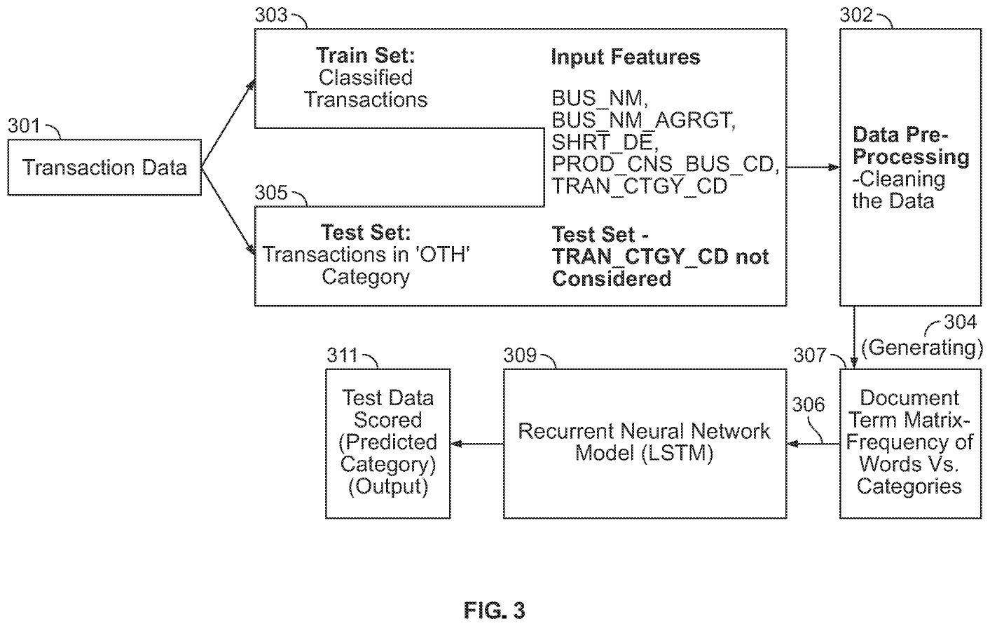

FIG. 3 shows an illustrative schematic in accordance with principles of the disclosure. Apparatus may include any of the components and systems odd-numbered 301 through 311, among other components. Methods may include some or all of the method steps even-numbered 302 through 306, as well as additional steps. Methods may include the steps illustrated in FIG. 3 in an order different from the illustrated order. The illustrative method shown in FIG. 3 may include one or more steps performed in other figures or described herein. Steps 302 through 306 may be performed on the apparatus shown in FIGS. 1-2 or other apparatus shown in other figures or elsewhere.

At step 302, transaction data 301, which may include a training set 303 and a test set 305, may be pre-processed. Preprocessing may clean the data within the transaction data 301. Cleaning may refer to removing whitespaces, trailing blanks, punctuation and other extraneous data from within the transaction data 301.

At step 304, an intelligent transaction classifying computer program may generate a document term matrix 307 from the data in the training set 303.

At step 306, the test set 305 may be analyzed by a recurrent neural network model (which may be a long-short term memory model) 309 to generate a predicted transaction category code 311.

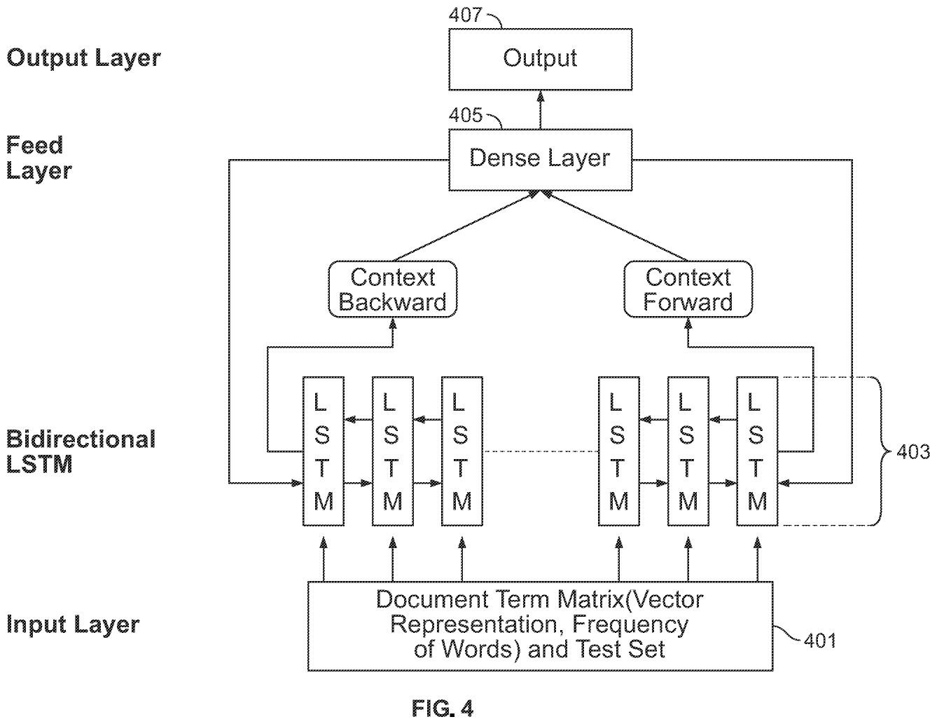

FIG. 4 shows an illustrative schematic in accordance with principles of the disclosure. FIG. 4 displays an exemplary recurrent neural network that may be used by a transaction classifying computer program.

The input layer 401 may include a document term matrix generated from a training set of transaction data. The input layer may also include unigrams derived from a test set of transaction data.

The input layer 401 may be directed into multiple long-short term memory model units 403 for analysis. The LSTMs 403 may be bi-directional, in that they may analyze the context of each test unigram, in any direction (subsequent and preceding unigrams, as well as distant unigrams in either direction). The LSTMs 403 may comprise the dense layer 405. The analysis may be iterated until a pre-determined threshold of predicted accuracy is reached. The recurrent neural network may include an output layer 407. The output may be a predicted transaction category code. The more LSTM units 403 used by the program, the faster and more accurate the program may be. Each LSTM 403 may be on a separate computing device, utilize a separate processor, or utilize a separate core of a multi-core microprocessor.

Each LSTM 403 may be run concurrently with every other LSTM 403. In an embodiment, each LSTM 403 may be run consecutively. However, this may take longer than running each LSTM 403 concurrently.

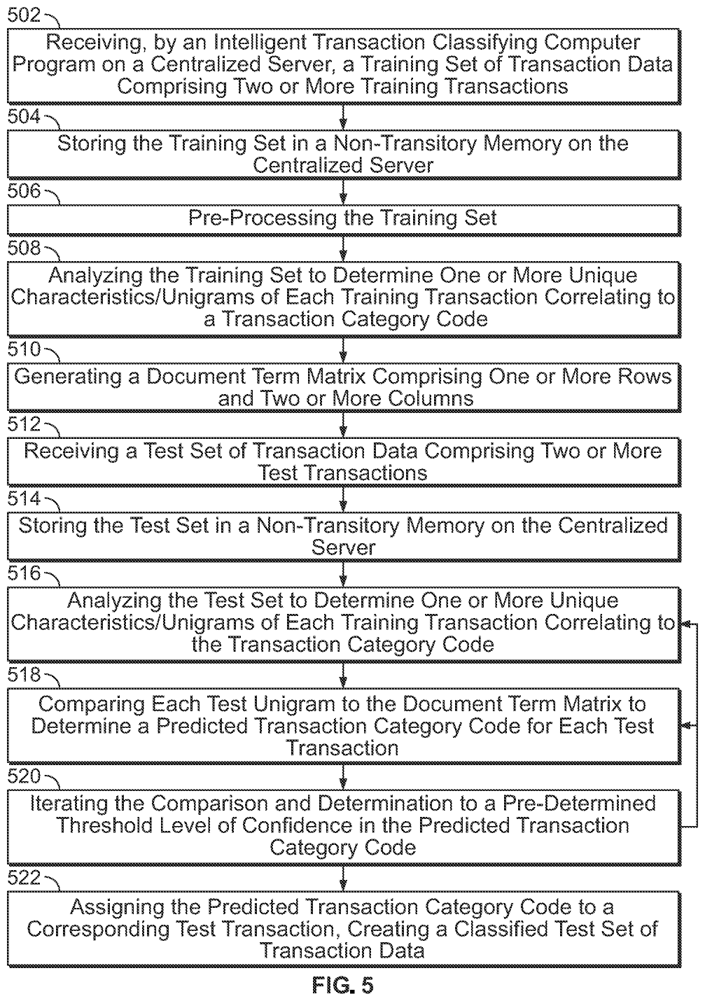

FIG. 5 shows an illustrative flowchart in accordance with principles of the disclosure. Methods may include some or all of the method steps numbered 502 through 522. Methods may include the steps illustrated in FIG. 5 in an order different from the illustrated order. The illustrative method shown in FIG. 5 may include one or more steps performed in other figures or described herein. Steps 502 through 522 may be performed on the apparatus shown in FIGS. 1-2 or other apparatus.

At step 502, an intelligent transaction classifying computer program (on a centralized server or other computer system) may receive a training set of transaction data. The transaction data may include two or more training transactions. Each training transaction may include a business name, a short description, a transaction category code, and other information.

At step 504, the program may store the training set in non-transitory memory, on the server or elsewhere.

At step 506, the program may pre-process the training set of transaction data by removing whitespaces, trailing blanks, punctuation, and other extraneous data.

At step 508, the program may analyze through one or more artificial intelligence/machine learning (“AI/ML”) algorithms, the training set to determine one or more unique characteristics of each training transaction correlating to the transaction category code. Each of the one or more unique characteristics may include a training unigram. The characteristics may include one or more frequencies of each training unigram (i.e., frequency of appearance within the training set and frequency of appearance with a particular transaction category code).

At step 510, the program may generate a document term matrix from the training set. The document term matrix may include one or more rows and two or more columns. Each row may include one of the training unigrams along with its associated data in various columns. One column may be a frequency of each unigram within the training set or correlated to a particular transaction category code. One column may be an associated transaction category code for a particular unigram.

At step 512, the program may receive a test set of transaction data. Each transaction within the test set may have an unclassified transaction category code of “OTHER” or other exemplary indicator of no classification.

At step 514, the program may store the test set in non-transitory memory.

At step 516, the program may analyze, through one or more AI/ML algorithms, the test set to determine one or more unique characteristics of each test transaction. Each of the one or more unique characteristics may include a test unigram.

At step 518, the program may compare, through one or more comparison artificial intelligence/machine learning (“cAI/ML”) algorithms, each test unigram to the document term matrix to determine a predicted transaction category code for each test transaction.

At step 520, the program may iterate the comparison and determinations until a pre-determined threshold level of confidence in the predicted transaction category code is reached.

In an embodiment, the program may automatically modify the threshold level as it learns from past history. For example, if the program is generating too many unknown predicted transaction category codes, it may lower the threshold level.

At step 522, the program may assign the predicted transaction category code to a corresponding test transaction, creating a classified test set of transaction data. In an embodiment, the classified test set may be added to the training set, creating a new, expanded training set of transaction data.

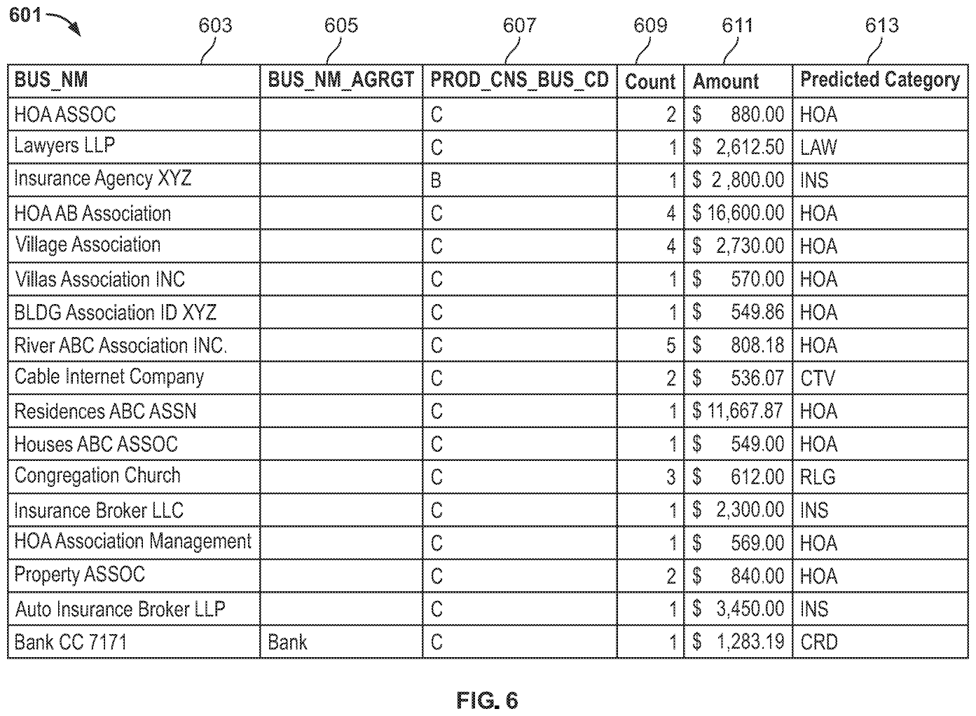

FIG. 6 shows an illustrative transaction data set in accordance with principles of the disclosure. An exemplary transaction data set 601 may include the following information: business name 603; business name aggregate 605; product consumer business code 607; count 609; amount 611; and transaction category code 613.

The business name 603 may be the proper legal name of the business entity where the transaction took place. The business name may be set by the entity when the entity registers for a particular financial service.

Business name aggregate 605 may be a shortened or aggregated name based on the business name. Shortening the name may be useful with larger transaction data sets. For example if the same financial institution appears in 5000 transactions, the proper business name may be shortened/aggregated for easier use.

The product consumer business code 607 may be a code that describes whether the transaction is between a consumer and an entity, or between two or more entities (businesses). Other descriptions may be used as well.

A transaction data set 601 may also include a short description (not shown) of the transaction. The short description may be set by the entity.

The count 609 may include the amount of times a transaction appears in the transaction data set. For example, recurring payments (e.g., a mortgage payment) may appear multiple times in a particular transaction set, but each appearance may be identical in entities and amounts.

The amount 611 may be the transaction amount associated with a particular transaction.

The transaction category code 613 may be an assigned category code or may be a predicted category code.

Thus, apparatus and methods for intelligently classifying unclassified transactions within a larger set of transactions are provided. Persons skilled in the art will appreciate that the present invention can be practiced by other than the described embodiments, which are presented for purposes of illustration rather than of limitation.

What is claimed is:

1. An intelligent transaction classifying computer program product, the computer program product comprising executable instructions, the executable instructions when executed by a processor on a computer system:
receive a training set of transaction data comprising two or more training transactions, each training transaction comprising:
1) a business name;
2) a short description; and
3) a transaction category code;
store the training set in a non-transitory memory;
pre-process the training set;
analyze, through one or more artificial intelligence/machine learning (“AI/ML”) algorithms, the training set to determine one or more unique characteristics of each training transaction correlating to the transaction category code, wherein each of the one or more unique characteristics comprises a training unigram;
generate a document term matrix wherein each row comprises one of the training unigrams, one column comprises a frequency of each unigram within the training set, and one column comprises an associated transaction category code;
receive a test set of transaction data comprising two or more test transactions, each test transaction comprising:
1) a business name;
2) a short description; and
3) an “OTHER” transaction category code;
store the test set in the non-transitory memory;
pre-process the test set;
analyze, through one or more artificial intelligence/machine learning (“AI/ML”) algorithms, the test set to determine one or more unique characteristics of each test transaction, wherein each of the one or more unique characteristics comprises a test unigram;
compare, through one or more comparison artificial intelligence/machine learning (“cAI/ML”) algorithms, each test unigram to the document term matrix to determine a predicted transaction category code for each test transaction;
iterate the comparison and determination to a pre-determined threshold level of confidence in the predicted transaction category code; and
assign the predicted transaction category code to a corresponding test transaction, creating a classified test set of transaction data.

2. The intelligent transaction classifying computer program product of claim 1 wherein the classified test set of transaction data is added to the training set.

3. The intelligent transaction classifying computer program product of claim 1 wherein the pre-processing comprises removing whitespace.

4. The intelligent transaction classifying computer program product of claim 1 wherein the pre-processing comprises removing punctuation marks.

5. The intelligent transaction classifying computer program product of claim 1 wherein one of the one or more cAI/ML algorithms is a recurrent neural network model.

6. The intelligent transaction classifying computer program product of claim 5 wherein the recurrent neural network model is a long-short term memory model (“LSTM”).

7. The intelligent transaction classifying computer program product of claim 6 wherein the LSTM is bidirectional.

8. The intelligent transaction classifying computer program product of claim 1 wherein each training transaction further comprises a business name aggregate.

9. The intelligent transaction classifying computer program product of claim 1 wherein each test transaction further comprises a business name aggregate.

10. The intelligent transaction classifying computer program product of claim 1 wherein the training set comprises more than seven hundred unique transaction category codes.

11. An intelligent transaction classifying computer program product, the computer program product comprising executable instructions, the executable instructions when executed by a processor on a computer system:
receive a set of transaction data comprising two or more transactions, each transaction comprising:
1) a business name;
2) a short description;
3) a business name aggregate; and
4) a transaction category code;
store the set in a non-transitory memory;
pre-process the set;
divide the set into one or more training transactions and one or more test transactions, wherein the one or more test transactions each have a transaction category code labeled as OTHER;
generate a training document term matrix from the one or more training transactions, wherein each row comprises a training unigram, one column comprises a frequency of each training unigram within the set, and one column comprises an associated transaction category code, and wherein the training unigram is taken from the business name, the short description, or the business name aggregate;
generate a test document term matrix from the one or more test transactions, wherein each row comprises a test unigram, one column comprises a frequency of each test unigram within the set, and one column is empty, and wherein the test unigram is taken from the business name, the short description, or the business name aggregate;
complete the test document term matrix by comparing, through one or more comparison artificial intelligence/machine learning (“cAI/ML”) algorithms, each test unigram to the training document term matrix to determine a predicted transaction category code for each of the one or more test transactions;
iterate the completion and determination to a pre-determined threshold level of confidence in the predicted transaction category code;
assign the predicted transaction category code to a corresponding test transaction of the one or more test transactions, creating a classified set of transaction data.

12. The intelligent transaction classifying computer program product of claim 11 wherein the predicted transaction category code is OTHER.

13. The intelligent transaction classifying computer program product of claim 11 wherein the pre-determined threshold level of confidence is modifiable.

14. The intelligent transaction classifying computer program product of claim 13 wherein an artificial intelligence/machine learning (“AI/ML”) algorithm modifies the pre-determined threshold level.

15. The intelligent transaction classifying computer program product of claim 11 wherein a system administrator adjusts the pre-determined threshold level of confidence.

16. The intelligent transaction classifying computer program product of claim 11 wherein the classified set of transaction data is data-mined.

17. The intelligent transaction classifying computer program product of claim 16 wherein an artificial intelligence/machine learning (“AI/ML”) algorithm data-mines the classified set of transaction data.

18. A method for intelligently classifying transactions, the method comprising the steps of:
receiving, by an intelligent transaction classifying computer program on a centralized server, a training set of transaction data comprising two or more training transactions, each training transaction comprising:
1) a business name;
2) a short description; and
3) a transaction category code;
storing the training set in a non-transitory memory on the centralized server;
pre-processing, by the computer program, the training set;
analyzing, by the computer program and through one or more artificial intelligence/machine learning (“AI/ML”) algorithms, the training set to determine one or more unique characteristics of each training transaction correlating to the transaction category code, wherein each of the one or more unique characteristics comprises a training unigram;
generating, by the computer program, a document term matrix comprising one or more rows and two or more columns, wherein each row comprises one of the training unigrams, one column comprises a frequency of each unigram within the training set, and one column comprises an associated transaction category code;
receiving, by the computer program, a test set of transaction data comprising two or more test transactions, each test transaction comprising:
1) a business name;
2) a short description; and
3) an “OTHER” transaction category code;
storing the test set in the non-transitory memory;
pre-processing, by the computer program, the test set;
analyzing, by the computer program and through one or more artificial intelligence/machine learning (“AI/ML”) algorithms, the test set to determine one or more unique characteristics of each test transaction, wherein each of the one or more unique characteristics comprises a test unigram;
comparing, by the computer program and through one or more comparison artificial intelligence/machine learning (“cAI/ML”) algorithms, each test unigram to the document term matrix to determine a predicted transaction category code for each test transaction;
iterating, by the computer program, the comparison and determination to a pre-determined threshold level of confidence in the predicted transaction category code; and
assigning, by the computer program, the predicted transaction category code to a corresponding test transaction, creating a classified test set of transaction data.

19. The method of claim 18 wherein one of the one or more cAI/ML algorithms is a recurrent neural network model.

20. The method of claim 19 wherein the recurrent neural network model is a long-short term memory model (“LSTM”).
